(19) United States
(12) Patent Application Publication
(10) Pub. No.: US 2004/0162820 A1
(43) Pub. Date: Aug. 19, 2004

(54) Search cart for search results

(76) Inventors: Taylor James, Ashburn, VA (US); Gerry Campbell, Ashburn, VA (US)

Correspondence Address: GLENN PATENT GROUP, 3475 EDISON WAY, SUITE L, MENLO PARK, CA, 94025, US

(21) Appl. No.: 10/719,483

(22) Filed: Nov. 21, 2003

Related U.S. Application Data
(60) Provisional application No. 60/427,949, filed on Nov. 21, 2002.

(51) Int. Cl. G06F 7/00

(52) U.S. Cl. 707/3

(57) ABSTRACT

The invention provides a search cart into which search results may be placed and with which search results may be used. For example, a user can select a result from among a listing of search results without having to click through to the result. Thus, results may be saved from within a search results page. The search cart is superficially similar to a shopping cart in that the user is able to go through a list of search results and select those results that the user would like to place in the cart. Once the user has gone through the initial search, the user can then go to the cart and search through the results in the cart.

This application claims the benefit of the U.S. Provisional Application No. 60/427,949 entitled “Personal Navigation” filed on 21 Nov. 2002.

### BACKGROUND OF THE INVENTION

1. Technical Field

The invention relates to on-line searching. More particularly, the invention relates to a search cart that allows persons to select various sites from among search results and easily scroll through the selected sites without having to go back to a search results page.

2. Description of the Prior Art

It is a common, everyday experience for many persons to search on-line through volumes of information contained in a multitude of databases using a search engine, such as Yahoo® or Google®. FIG. 1 provides an example of a listing of results obtained 11 when the query “search engine” 12 is entered into the Google® search engine. In this example, the user is shown the first ten sites from a set of 9,780,000 results 13. The user may select any of the results to navigate to the various sites located during the search. If the user intends to return to a particular site, then the site may be bookmarked (see FIG. 2). A user may go to the set of bookmarks 21 at some later time and revisit a particular site by selecting the bookmark. The bookmark thus serves as a mechanism for permanently saving information about a site.

Bookmarks may be organized by subject or topic in sets 22 for convenient access when needed, as shown in FIG. 2. The act of saving a bookmark while navigating a current set of search results stores access information 23 in the bookmark folder, along with all other bookmarks from all other searches, as well as with any other bookmarks that were saved during user navigation, i.e. bookmarks that were added outside of a search. Thus, the bookmark mechanism provides the user with the ability to build a database of sites for further access in the future. However, there is no notion of currency in the bookmark metaphor. That is, the saving of a bookmark does not help a user sort through a current search.

As can be seen from the partial search results shown in FIG. 1, the user must select from among many results, at least some of which are of no interest to the user. This is presently accomplished by actually visiting a site of interest, i.e. by selecting the site from the list of search results, and then navigating back to the search results to visit another site. Typically, a user can identify sites that may be of interest by reviewing the partial description 14 of the site, typically a text clipping, which appears as part of the site's entry in the list of search results. The user can skip those sites that are not of interest and visit only those sites that appear to match the user's intended search criteria. This winnowing of results is necessary because on-line search engines produce inexact results, and user's typically posit vague queries that also contribute to the ambiguity of the search results.

It is confusing and time consuming to visit a site, return to the list of search results, skip down through sites that do not appear to be of interest, visit another site, and repeat this process over several pages of search results. While most browsers maintain a history of a user's current navigation session, thus allowing a user to return to the listing of search results to continue through the listing, such history does not identify which sites were found to be of interest and which were not of interest. Further, a history does not include descriptive information of sites visited, but merely stores a listing of the site addresses, i.e. URLs.

It would be advantageous to allow a user to produce from an initial listing of search results a short list of results that contains only sites of interest to the user. While the user could bookmark sites of interest as he proceeds through the list of search results, such mechanism first requires the user to visit a site before the site information can be captured in the bookmark list. Further, as noted above, a list of bookmarks is cumulative over many searches and navigation sessions and does not lend itself to maintenance of a list of sites of interest that a user identifies from among current search results.

It is known to use a shopping cart for saving information with regard to ordering products that have been selected from a list of products by a user. However, a shopping cart is more in the nature of a list of bookmarks in that it is cumulative over multiple searches, i.e. a user typically identifies a product of interest and saves it to the shopping cart, then moves on to identify another type of product, i.e. the user commences another search. Accordingly, the shopping cart metaphor provides little guidance toward solving the problem of producing a listing of sites of interest, and only those sites of interest, from among the many results returned for a current search.

### SUMMARY OF THE INVENTION

The invention provides a search cart into which search results may be placed and with which search results may be used. For example, a user can select a result from a listing of results without having to click through to the result. Thus, search results may be saved from within a search results page. The search cart is superficially similar to a shopping cart in that the user is able to go through a list of search results and select those results that the user would like to place in the cart. Once the user has gone through the initial search, the user can then go to the cart and search through the results in the cart.

### BRIEF DESCRIPTION OF THE DRAWINGS

FIG. 1 is a screen shot showing a page of search results;

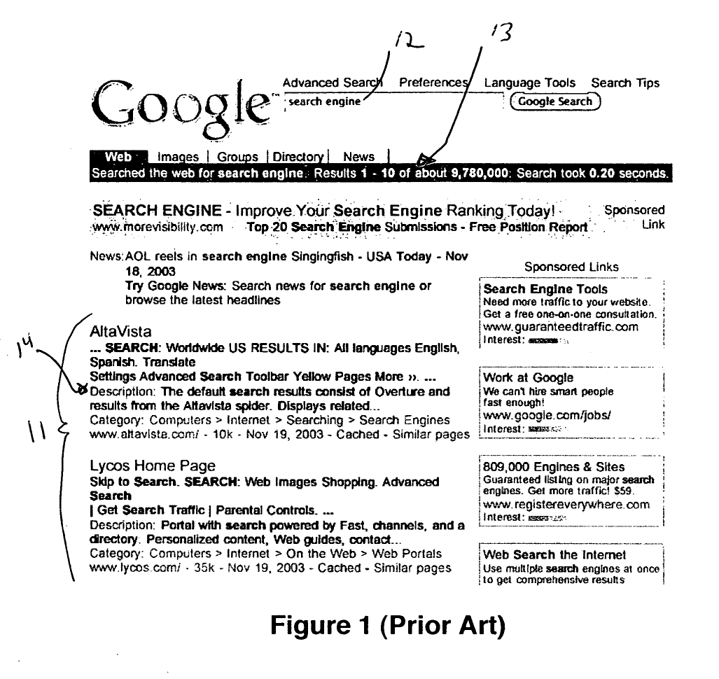

FIG. 2 is a screen shot showing a listing of bookmarks;

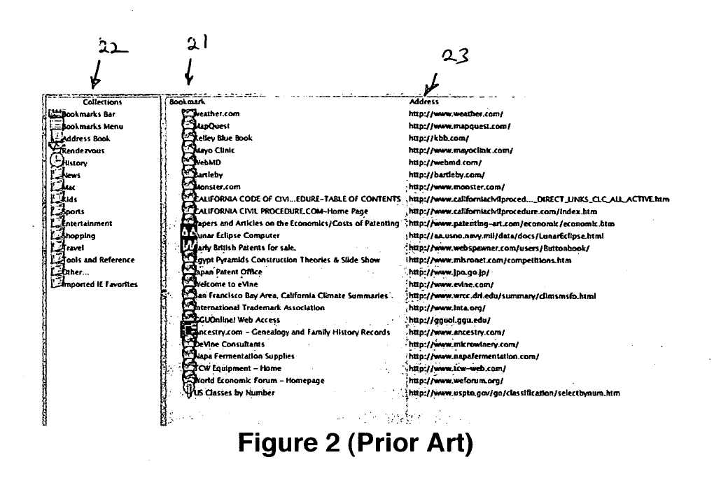

FIG. 3 is a screen shot showing a page of search results in which results of interest have been marked and added to a search cart according to the invention;

FIG. 4 is a screen shot showing a search side bar according to the invention; and

FIG. 5 is a block schematic diagram of a search system according to the invention.

### DETAILED DESCRIPTION OF THE INVENTION

The invention allows the user to visit sites of interest from within a search cart without having to click through and click back to results produced through an initial search strategy. Thus, a user can cherry-pick those results that seem to be of interest from the initial search results and then use the search cart to delve deeper into the results that are of interest. The presently preferred embodiment is a client-based solution, but the invention is readily adapted for server-centric applications as well.

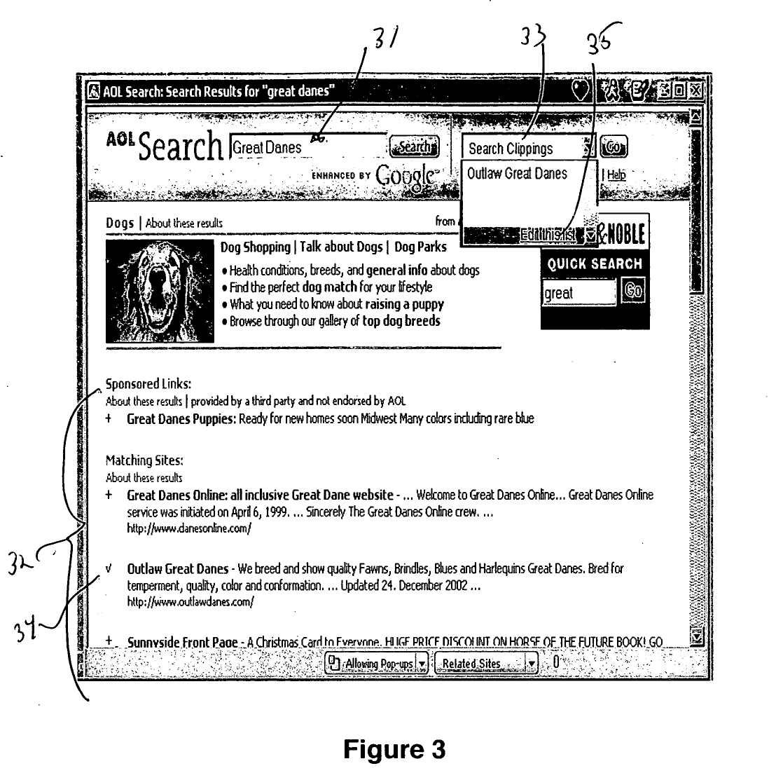

FIG. 3 is a screen shot showing a page of search results in which results of interest have been marked and added to a search cart according to the invention. As shown in FIG. 3, a user has initiated a search for information “Great Danes” and the search engine, here AOL Search, has returned a listing 32 of sites that match the search criteria. As the user reviews the listing, he is able to identify those sites that are of interest by using a mouse-over click gesture to check the listing for such sites. Thus in FIG. 3, the user has placed a check mark 33 by the listing for “Outlaw Great Danes.” While a check mark is shown in the example of FIG. 3, those skilled in the art will appreciate that other indicia may be used to designate sites of interest. As well, other gestures may be employed by the user to select those sites of interest.

In the embodiment of FIG. 3, a pull down search clippings window 33 is provided from which the user may select those sites which were saved from the initial listing of search results. In the example of FIG. 3, the listing for “Outlaw Great Danes” was selected by the user, and an entry for this listing appears in the search clippings window. When the user selects this entry, for example by a mouse-over click or other gesture, the user is taken the site associated with the entry. While only one entry is shown in the search clippings window, it will be appreciated that the search clippings window may contain several entries, once a user has finished reviewing the initial search results. At any appropriate time, the user may edit the list of sites in the search clippings window by selecting an “Edit this list” button 35.

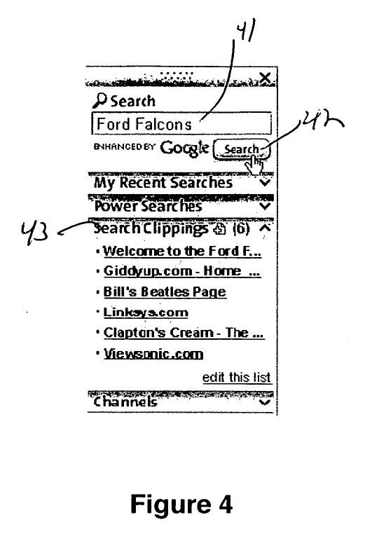

FIG. 4 is a screen shot showing a search side bar according to the invention. In FIG. 4, access to a search engine is provided by a search entry window 41 and “Search” button 42. Several tabs for side bar pull downs are also provided, among which is a tab for a search clippings pull down 43. As with the embodiment of FIG. 3, a user enters search criteria and reviews a returned search result listing. The user selects sites that are of interest and these sites are added to the search clippings pull down. The user may then select those sites of interest from the search clippings pull down.

According to the invention, a user is able to select search results to save to a temporary search cart. Thus, a user is able to place search results within their search cart. Users are also able to select a result from a search query without having to click through to the result. It should be appreciated that a search for purposes of the invention need not be a conventional Web search as described above, but may be any type of search, such as a content search, file search, and the like. For example, the query results can include any of the following:

a Recommended Sites

Sponsored Links

Matching Sites

As discussed above, users are able to edit and/or delete from the search cart. Thus, the user is able to clear all entries or clear individual sites, as desired.

In the presently preferred embodiment, saved sites are saved in chronological order, where most recent sites are displayed at the top of the list.

One embodiment provides a temporary queue to make it easier for users to sort through selected results quickly during their search session. In this embodiment, saved sites are not saved across sessions. As soon as a user closes out of search, the search cart is closed and emptied. In other embodiments, a user may designate certain sites within the search cart for transfer to the bookmarks list. This allows the user to save access information for these sites for use after a current session has ended.

The preferred embodiment of the invention is implemented as a client side extension to a standard browser. This extension may be so implemented in any of several ways, as would be within the skill of those practiced in the art. For example, the invention may be downloaded to the user's browser as an applet in the form of XML, Java, or JavaScript; the invention may be a plug-in to a standard browser; or the invention may be built into a standard browser. Further, the invention may be implemented in a server application, for example as part of a search engine. Finally, a Web site may be provided which comprises a search portal that implements the herein disclosed invention. For example, a user query form may be provided that includes both a mechanism for selecting sites of interest from among a listing of initial search results, and the also provides a sidebar, pull down, or other user interface mechanism for presenting these selected sites to a user for navigation.

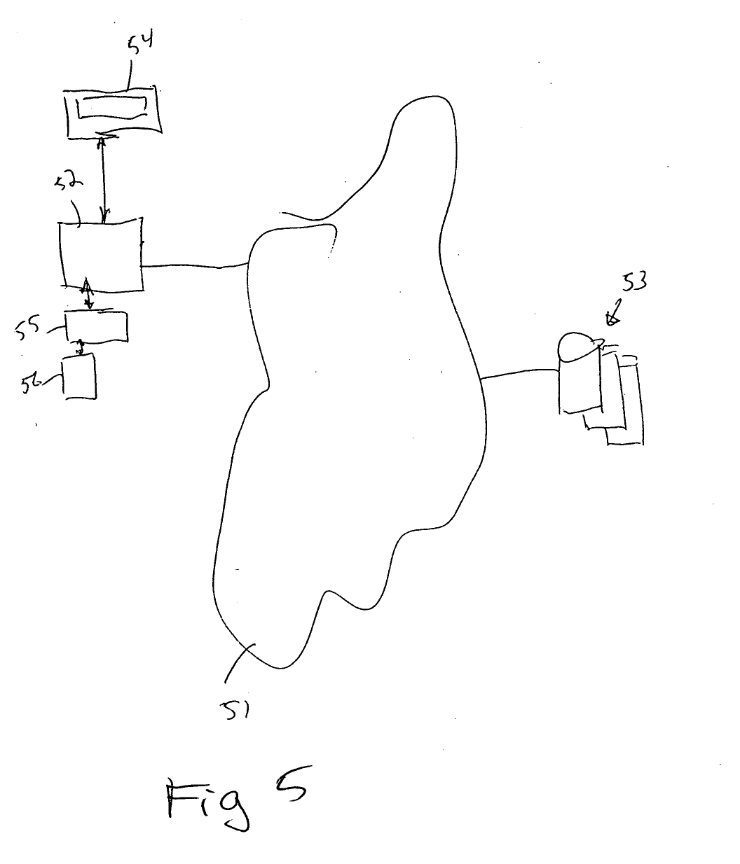

FIG. 5 is a block schematic diagram of a search system according to the invention. The invention is readily adapted to existing systems using known mechanisms, as discussed above. A typical configuration would comprise a search facility 53 which hosts a user access portal, such as a Web server, and a search module that processes user queries received through the access portal and that searches one or more databases for matches to the user query. The user accesses the search facility via a global telecommunications network, such as the Internet 51, via a user terminal 52, which in this example is a personal computer, but which may be any other similar device, such as a PDA, cell phone, and the like. The user terminal includes a display 54 which presents user interface elements, such as those described above in connection with FIGS. 3 and 4, to the user. The user terminal also includes a client application, such as a browser 55. A plug-in or applet 56 provides additional functionality to the browser to implement the features of the invention described herein.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A search method, comprising the steps of:
a user positing a query to a search engine;
a first list of search results being returned to said user by said search engine in response to said query, said search results each associated with one or more Web sites;
providing a selection mechanism within said first list that allows said user to identify search results of interest from among those search results within said first list;
said user applying a gesture to said selection mechanism to identify search results of interest from among those search results within said first list;
providing a second list of search results to which said search results of interest may be added;
adding said search results of interest to said second list in response to said user gesture; and
allowing a user to visit Web sites associated said search results of interest from said second list without having to select and return to said first list of search results.

2. The method of claim 1, wherein said search method is implemented in a user client.

3. The method of claim 2, wherein said user client is a browser.

4. The method of claim 1, wherein said method is implemented in a server.

5. The method of claim 1, wherein said user gesture is a mouse-over click gesture.

6. The method of claim 1, wherein said second list is any of a pull down and a side bar.

7. The method of claim 1, wherein said selection mechanism comprises a separate checkbox associated with each of said search results in said first list.

8. The method of claim 1, further comprising the step of:
providing an edit facility for entries made to said second list.

9. The method of claim 8, said edit facility providing functionality for any of editing entries, clearing all entries, and clearing individual sites.

10. The method of claim 1, wherein said search comprises any of a content search, file search, and a database search.

11. The method of claim 1, further comprising the step of:
saving entries in said second list in chronological order, where most recent sites are displayed at a top of said second list.

12. The method of claim 1, wherein said second list comprises a temporary queue in which entries are not saved across search sessions.

13. The method of claim 1, further comprising the step of:
said user designating selected entries within said second list for transfer to a bookmarks list to save information related to said selected entries for use after a current search session has ended.

14. The method of claim 1, wherein said search method is implemented in a search portal.

15. A search apparatus, comprising:
a search engine to which a user posits a query;
said search engine returning a first list of search results to said user in response to said query, said search results each associated with one or more Web sites;
a selection mechanism within said first list that allows said user to identify search results of interest from among those search results within said first list;
means for said user applying a gesture to said selection mechanism to identify search results of interest from among those search results within said first list;
a second list of search results to which said search results of interest may be added, wherein said search results of interest are added to said second list in response to said user gesture; and
means for allowing a user to visit Web sites associated said search results of interest from said second list without having to select and return to said first list of search results.

16. The apparatus of claim 15, wherein said search apparatus is implemented in a user client.

17. The apparatus of claim 16, wherein said user client is a browser.

18. The apparatus of claim 15, wherein said search apparatus is implemented in a server.

19. The apparatus of claim 15, wherein said user gesture is a mouse-over click gesture.

20. The apparatus of claim 15, wherein said second list is any of a pull down and a side bar.

21. The apparatus of claim 15 wherein said selection mechanism comprises a separate checkbox associated with each of said search results in said first list.

22. The apparatus of claim 15, further comprising:
an edit facility for entries made to said second list.

23. The apparatus of claim 22, said edit facility providing functionality for any of editing entries, clearing all entries, and clearing individual sites.

24. The apparatus of claim 15, wherein said search comprises any of a content search, file search, and a database search.

25. The apparatus of claim 15, further comprising:
means for saving entries in said second list in chronological order, where most recent sites are displayed at a top of said second list.

26. The apparatus of claim 15, wherein said second list comprises a temporary queue in which entries are not saved across search sessions.

27. The apparatus of claim 15, further comprising:
means for said user designating selected entries within said second list for transfer to a bookmarks list to save information related to said selected entries for use after a current search session has ended.

28. The apparatus of claim 15, wherein said search method is implemented in a search portal.
